(19) United States
(12) Patent Application Publication
(10) Pub. No.: US 2011/0096036 A1
(43) Pub. Date: Apr. 28, 2011

(54) METHOD AND DEVICE FOR AN ACOUSTIC SENSOR SWITCH

(76) Inventors: Jason McIntosh, Sugar Hill, GA (US); Marc Boillot, Plantation, FL (US)

(21) Appl. No.: 12/911,638

(22) Filed: Oct. 25, 2010

Related U.S. Application Data
(60) Provisional application No. 61/254,433, filed on Oct. 23, 2009.

(51) Int. Cl. G06F 3/043

(52) U.S. Cl. 345/177

(57) ABSTRACT

An acoustical sensor can include a fabricated surface that produces an acoustical sound signature responsive to a finger tapping on the fabricated surface, and a microphone within proximity of the fabricated surface to analyze and associate the acoustical sound signature with a user interface control for operating a mobile device or earpiece, for example, to adjust a volume, media selection, or user interface control. The microphone can include an ultra-low analog circuit to set a capacitance and establish a frequency response, the analog circuit programmable to identify a direction of a directional touch or localized touch on the fabricated surface. The analog circuit by way of a floating gate can control a real delay between a front and back diaphragm to control microphone directivity. Other embodiments are disclosed.

### CROSS-REFERENCE TO RELATED APPLICATION

This application is a Non-Provisional of U.S. Patent Application No. 61/254,443 filed on Oct. 23, 2009 the entire contents of which are hereby incorporated by reference.

### FIELD

The present embodiments of the invention generally relate to user interfaces, and more particularly to a method and device for acoustic sensor switches for user interface control.

### BACKGROUND

As mobile devices and earpieces become smaller in size so also does the surface area of the user interface. The soft keys and buttons on the device are generally limited in size by the surface area. The user interaction with such devices becomes more challenging as the user interface size decreases. The buttons are usually mechanical and prone to wear and tear; they also add to manufacturing cost. Moreover, the force a user applies to a button on a light weight earpiece tends to move and dislodge the earpiece from the ear.

### SUMMARY

Broadly stated, a low-cost acoustical sensor is provided as a substitute for electronic components or mechanical button user interface components. The acoustical sensor switch in one embodiment is directed to an earpiece and comprises a low-cost fabricated surface that produces an acoustical sound signature responsive to a finger movement thereon. In addition to the fabricated pattern, an optional underlying structure can be included to vibrate in response to the finger movement according to a structural modality. The acoustical sensor can complement or replace a touchpad, button, or other mechanical input device. A microphone within proximity of the fabricated surface captures the acoustical sound signature, where the microphone dually serves to capture acoustic voice signals. The acoustical sensor includes a processor communicatively coupled to the microphone that discriminates the acoustic voice signals and identifies the acoustical sound signature from i) vibrations of the underlying structure coupled to the fabricated surface, and ii) acoustical sound pressure waves of the acoustical sound signature generated in air, to analyze and associate the acoustical sound signature with a user interface control for operating a mobile device or earpiece attached thereto, where the microphone is adjacent to the fabricated surface or positioned within the fabricated surface.

The processor can identify locations of the finger movements corresponding to user interface controls; and discriminate between finger touches, tapping, and sliding on the fabricated surface at the locations, where the finger movement can be a left, right, up, down, clockwise or counter-clockwise circular movement. The processor can determine a direction of the finger movement by analyzing amplitude and frequency characteristics of the acoustical sound signature and comparing them to time segmented features of the fabricated surface, where the fabricated surface comprises structures of grooved inlets, elastic membranes, cilia fibers, or graded felt that vary in length and firmness. The processor can identify changes in the acoustical sound signatures generated from the fabricated surface over time and frequency responsive to a sweeping of the finger across the fabricated surface, where the fabricated surface is manufactured to exhibit physical structures that produce distinguishing characteristics of the acoustical sound signature responsive to directional touch.

The fabricated surface can comprise a non-linearly spaced saw tooth pattern to produce frequency dependent acoustic patterns based on the directional movement of directional touch on the fabricated surface. The fabricated surface can be a function of surface roughness along two dimensions, and the surface roughness changes from left to right with a first type of material variation, and the surface roughness changes from bottom to top with a second type of material variation, so at least two dimensional rubbing directions can be determined.

In one arrangement, the microphone can be asymmetrically positioned within the fabricated surface for distinguishing approximately straight-line finger-sweeps from a locus of points on the exterior of the fabricated surface inwards toward the microphone, or, oblong for distinguishing a direction of an approximately straight-line finger sweep from an exterior of the fabricated surface inwards to the microphone. As one example, the microphone comprises an ultra-low analog circuit with at least one reverse diode junction to set a capacitance and establish a frequency response for identifying the direction of the directional touch. A second microphone can be further provided, where the fabricated surface approximates an elliptical pattern and the first microphone and second microphone are positioned at approximately the focal points of the elliptical pattern. In this arrangement, the processor can track finger movement across the fabricated surface by time of flight and phase variations of the acoustical sound signatures captured at the first and second microphone. It can distinguish between absolute finger location based on time of flight and relative finger movement based on phase differences for associating with the user interface controls.

In a second embodiment, an acoustical sensor suitable for an earpiece can include a fabricated surface to produce an acoustical sound signature responsive to a surface slide finger movement and localized finger tap (e.g., adjust and confirm), a microphone within proximity of the fabricated surface to capture the acoustical sound signature, and a processor to identify a movement and location of the localized touch responsive to detecting the acoustical sound signature for operating a user interface control of the earpiece. The microphone can comprise an ultra-low power analog circuit with at least one reverse diode junction to set a capacitance to establish a characteristic frequency response and recognize an acoustical sound signature at a location on the fabricated surface. The reverse diode junction can be a programmable or adaptive floating gate that changes analog transfer characteristics of the analog circuit to identify the direction of the directional touch, and adjusts the frequency response by way of a controlled electron source to adjust the capacitance of reverse junction. The fabricated surface can include a modal membrane or plate or combination thereof that excites modal acoustic patterns responsive to the localized touch, and the localized touch is a finger touch, tap or slide movement on a modal zone of the fabricated surface, where the material surface is a modal membrane that by way of the localized touch excites modal acoustic patterns detected by the microphone.

In one arrangement, the microphone can include a diaphragm with a front and a back port to delay a propagation of the acoustical sound signature from the front port to the back port of the diaphragm to create microphone directional sensitivity patterns for identifying the direction of the directional touch. The processor can introduce a phase delay between the acoustical sound signature captured at the front port and the same acoustical sound signature captured at the back port to generate a directional sensitivity for increasing a signal to noise ratio of the acoustical sound signature. A second microphone can be positioned to detect changes in sound pressure level of the acoustical sound signature between the at least one more microphones, and from the changes identify a direction of the finger movement from the acoustical sound signatures. The processor can digitally separate and suppress acoustic waveforms caused by the finger movement on the fabricated surface from acoustic voice signals captured at the microphone according to detected vibrations patterns on the fabricated surface. It can also operate in a low power processing mode to periodically poll the voice signals from the microphone to enter a wake mode responsive to identifying acoustic activity.

In a third embodiment, an earpiece can include a fabricated surface to produce an acoustical sound and vibration patterns responsive to a finger movement on the fabricated surface on the earpiece, a microphone to capture the acoustical and vibration sound signatures due to the finger movement, and a processor operatively coupled to the microphone to analyze and identify the high frequency acoustical and low frequency vibration sound signatures and perform a user interface action therefrom. The microphone can be embedded in a housing of the earpiece to sense acoustic vibration responsive to finger movement on the fabricated surface of the earpiece. The fabricated surface can be a grooved plastic, jagged plastic, a graded fabric, a textured fiber, elastic membranes, or cilia fibers, but is not limited to these.

In one arrangement, the fabricated surface can be a modal membrane or plate with variations in stiffness, tension, thickness, or shape at predetermined locations to excite different modal patterns and produce acoustical sound signatures characteristic to a location of a finger tap on the modal membrane, and

the processor identifies a location of the finger tap to associate with the user interface action, a direction of the touching to associate with the user interface action, or a combination thereof. The processor can monitor a sound pressure level at a first microphone and a second microphone responsive to a finger moving along the material surface, track the finger movement along the material surface based on changes in the sound pressure level and frequency characteristics over time, recognize finger patterns from the tracking to associate with the user interface action, and determine correlations among acoustical sound signatures as a finger touching the material surface moves from a first region of the fabricated surface to another region of the fabricated surface to determine which direction the finger is traveling, The processor can detect form the correlations a finger motion on the fabricated surface that is a left, right, up, down, tap, clockwise or counter-clockwise circular movement. The mechanical properties vary in thickness, stiffness, or shape and include a thin layer that produces higher frequencies and a thick layer that produces lower frequencies. The processor can further learn acoustical sound signatures for custom fabricated surfaces, generate models for the sound signatures as part of the learning, and save the models for retrieval upon the occurrence of new sound signatures. The models can be Neural Network Models, Gaussian Mixture Models, or Hidden Markov Models, but are not limited to these.

### BRIEF DESCRIPTION OF THE DRAWINGS

The features of the embodiments of the invention, which are believed to be novel, are set forth with particularity in the appended claims. Embodiments of the invention, together with further objects and advantages thereof, may best be understood by reference to the following description, taken in conjunction with the accompanying drawings, in the several figures of which like reference numerals identify like elements, and in which:

FIG. 1 depicts an exemplary acoustical sensor switch in accordance with one embodiment;

FIG. 2 depicts an exemplary block diagram of an acoustical sensor switch embodiment of a media controller in accordance with one embodiment;

FIG. 3 depicts an exemplary floating gate suitable for use in a microphone actuator accordance with one embodiment;

FIG. 4 depicts an exemplary microphone directional sensitivity pattern in accordance with one embodiment;

FIG. 5 depicts exemplary fabricated surfaces in accordance with one embodiment;

FIG. 6 depicts exemplary profiles of roughness of a fabricated surface in accordance with one embodiment;

FIG. 7 is an illustration depicting finger movement on a fabricated surface in accordance with one embodiment;

FIG. 8 depicts modal membranes on a fabricated surface to excite modal patterns responsive to touch in accordance with one embodiment;

FIG. 9 depicts an acoustical sensory with asymmetric microphone positioning in accordance with one embodiment;

FIG. 10 depicts a fabricated surface with fibers of varying properties in accordance with one embodiment;

FIG. 11 depicts an acoustical sensor formation in accordance with one embodiment;

FIG. 12 depicts an acoustic sensor switch with varying mechanical properties in accordance with one embodiment;

FIG. 13 depicts an exemplary acoustical sensor switch suitable for mounting or integration with an earpiece in accordance with one embodiment;

FIG. 14 depicts an exemplary acoustical sensor switch suitable for mounting or integration with a mobile device in accordance with one embodiment; and

FIG. 15 depicts an exemplary diagrammatic representation of a machine in the form of a computer system within which a set of instructions, when executed, may cause the machine to perform any one or more of the methodologies disclosed herein.

### DETAILED DESCRIPTION

Embodiments in accordance with the present disclosure provide a method and device for acoustic sensor switches and ultra-low power microphonic actuators.

In a first embodiment an acoustical sensor switch can include a fabricated surface that produces an acoustical sound pattern responsive to a finger tapping on the fabricated surface, and a microphone within proximity of the fabricated surface to analyze and associate the acoustical sound pattern with a user interface control for operating a mobile device or earpiece. The microphone can be programmatically configured to identify the acoustical sound patterns of the finger tapping at a particular location on the fabricated surface and/or on a housing or supporting structure of the microphone. The acoustical sensor switch can control a user interface of a mobile device or earpiece responsive to the finger tapping, for example, to adjust a volume, media selection, or user interface control. In one configuration, the fabricated surface can excite modal patterns in a material structure of the fabricated surface that are characteristic to a location of the finger tapping.

In a second embodiment an acoustical sensor switch can include a fabricated surface that produces an acoustical sound pattern responsive to a directional touch or slide on the fabricated surface, and a microphone within proximity of the fabricated surface to identify a direction of the directional touch responsive to measuring the acoustical sound pattern, and processing logic associated with the microphone to operate a user interface of a headset, earpiece or mobile device based on the direction of the directional touch. The directional touch can be a left swipe, right swipe, up swipe, down swipe, clockwise or counter-clockwise circular swipe motion. The fabricated surface can comprise structures of grooved inlets, roughness patterns, elastic membranes, cilia fibers, or graded felt that vary in length and firmness for emitting characteristic acoustical sound patterns. Processing logic associated with the microphone can identify changes in the acoustical sound pattern such as modal excitations from the fabricated surface over time and frequency responsive to the movement of the finger across the fabricated surface. The microphone can discriminate between a finger tip movement and a finger nail movement across the fabricated surface.

In a third embodiment a microphone can include an ultra-low analog circuit to set a capacitance and establish a frequency response, the analog circuit programmable to identify a direction of a directional touch or localized touch on a fabricated surface that produces an acoustical sound pattern responsive to the touch. The analog circuit can be a programmable or adaptive floating gate that changes analog transfer characteristics of the analog circuit to identify a direction of the directional touch or a location of the localized touch. As one example, this can be achieved via a reverse diode junction The microphone can associate the touch with a user interface command and actuate a corresponding operation command on a mobile device or earpiece for operating at least one user interface control.

In one arrangement the microphone can include a diaphragm with a front and a back port to delay a propagation of the acoustical sound pattern from the front port to the back port to create microphone directional sensitivity patterns for identifying acoustical sound patterns. Processing logic associated with the microphone can control the delay to adjust the directional sensitivity. The processing logic can also identify the acoustical sound pattern from vibrations of an underlying structure coupled to the fabricated surface in addition to the acoustical sound pressure waves generated in air. A secondary microphone of similar configuration can be positioned to detect changes in sound pressure level of the acoustical sound pattern between the two microphones, and from the changes identify a direction of the directional touch.

In a fourth embodiment, an earpiece can include a material surface to produce an acoustical sound pattern responsive to a touching of the material surface on the earpiece, a microphone to measure the acoustical sound pattern of the touching, and a processor operatively coupled to the microphone to perform a user interface action responsive to identifying the acoustical sound pattern. The microphone can identify a location of the touching to associate with the user interface action, a direction of the touching to associate with the user interface action, or a combination thereof. Processing logic associated with the microphone can discriminate between a finger tap and a finger gliding movement. In one arrangement, the processing logic can activate speech recognition responsive to detecting a finger tapping pattern of the microphone and load a word recognition vocabulary specific to the finger tapping or a location of the finger tapping, for example to control audio. A second finger tapping following the speech recognition of a spoken utterance can adjust a user interface control, such as a volume.

This application also incorporates by reference the following Utility Applications: U.S. patent application Ser. No. 11683,410 Attorney Docket No. B00.11 entitled “Method and System for Three-Dimensional Sensing” filed on Mar. 7, 2007 claiming priority on U.S. Provisional Application No. 60/779,868 filed Mar. 8, 2006, U.S. patent application Ser. No. 11/839,323 Attorney Docket No. B00.16 entitled “Method and Device for Planar Sensory Detection” filed on Aug. 15, 2007 claiming priority on U.S. Patent Application No. 60/837,685 filed on Aug. 15, 2006, U.S. patent application Ser. No. 11/844,329 Attorney Docket No. B00.17 entitled “Method and Device for a Touchless Interface” filed on Aug. 23, 2007 claiming priority on U.S. Patent Application No. 60/839,742 filed on Aug. 23, 2006, U.S. patent application Ser. No. 11/936,777 Attorney Docket No. B00.21 entitled “Method and Device for Touchless Signing and Recognition” filed on Nov. 7, 2007 claiming priority on U.S. Patent Application No. 60/865,166 filed on Nov. 9, 2006, U.S. patent application Ser. No. 11/930,014 Attorney Docket No. B00.20 entitled “Touchless User Interface for a Mobile Device” filed on Oct. 30, 2007 claiming priority on U.S. Patent Application No. 60/855,621 filed on Oct. 31, 2006, and U.S. Pat. No. 7,414,705 entitled “Method and System for Range Measurement”.

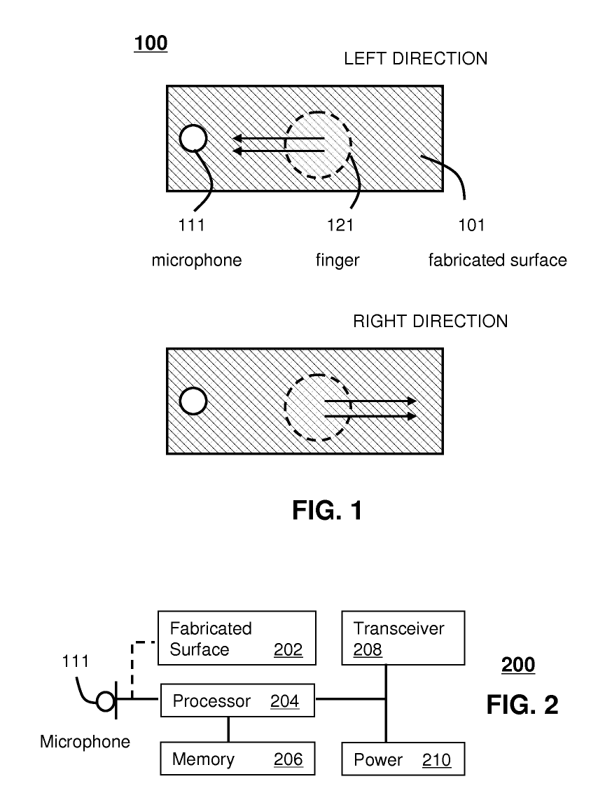

FIG. 1 shows an exemplary embodiment of an acoustical sensor switch 100. The acoustical sensor switch 100 can comprise a fabricated surface 101 that produces an acoustical sound pattern responsive to a directional touch on the fabricated surface 101, and a microphone 111 within proximity of the fabricated surface 101 to identify a direction of the directional touch responsive to measuring the acoustical sound pattern. Processing logic associated with the microphone can operate a user interface of a headset, earpiece or mobile device based on the direction of the directional touch. The processing logic can be integrated within the microphone 111, for example, as analog circuits, or external to the microphone 111, for example, as software.

As one example, the acoustical sensor switch 100 can monitor a sound pressure level at the microphone 111 to detect whether the finger traveling along the material surface is approaching or departing relative to the microphone 111. In the upper plot, the microphone 111 can detect left finger movement upon measuring increasing sound pressure levels of the acoustical sound pattern. In the lower plot, the microphone 111 can detect right finger movement upon measuring decreasing sound pressure levels of the acoustical sound pattern. The acoustical sensor 100 tracks characteristics, or salient features, of the acoustical sound pattern for recognizing the direction of finger movement.

FIG. 2 is a block diagram of the acoustical sensor switch according to one embodiment. As illustrated the acoustical sensor switch 200 comprises the microphone 111, the fabricated surface 202, a processor 204, a memory 206, a transceiver 208 and a power supply 208. It should be noted that the acoustical sensor switch 200 is not limited to the components shown. The acoustical sensor switch 200 may contain more or less than the number of components shown.

The microphone 111 can measure sound levels and features of acoustical sound patterns generated by the fabricated material 101 responsive to touch. The microphone dually serves to capture acoustic voice signals. For instance, in addition to listening for touches on the fabricated surface, the microphone 111 can be used to capture voice, for example, for voice calls, voice messages, speech recognition, and ambient sound monitoring. The microphone can be a micro-electro mechanical systems (MEMS), electret, piezoelectric, contact, pressure, or other type of microphone.

The processor 204 can utilize computing technologies such as a microprocessor, Application Specific Integrated Chip (ASIC), and/or digital signal processor (DSP) with associated storage memory 206 such a Flash, ROM, RAM, SRAM, DRAM or other like technologies for controlling operations of the acoustical sensor switch. Processing logic and memory associated with microphone for identifying characteristics of acoustical sound patterns can be resident on the processor 204, the microphone 111, or a combination thereof.

The transceiver 208 support singly or in combination any number of wireless access technologies including without limitation cordless phone technology (e.g., DECT), Bluetooth™, Wireless Fidelity (WiFi), Worldwide Interoperability for Microwave Access (WiMAX), Ultra Wide Band (UWB), software defined radio (SDR), and cellular access technologies such as CDMA-1×, W-CDMA/HSDPA, GSM/GPRS, TDMA/EDGE, and EVDO. Next generation wireless access technologies including Wi-Fi, ad-hoc, peer-to-peer and mesh networks can also be supported.

The power supply 210 can utilize common power management technologies such as replaceable batteries, supply regulation technologies, and charging system technologies for supplying energy to the components of the acoustical sensor switch 200 and to facilitate portable applications.

In one embodiment, the microphone 201 comprises an ultra-low analog circuit with at least one reverse diode junction to set a capacitance and establish a frequency response. The analog circuit can thus be programmed to identify a direction of a directional touch on the fabricated surface 202 responsive to the directional touch. The analog circuit can also identify a localized touch on the fabricated surface 202. The reverse diode junction can include a programmable or adaptive floating gate that changes analog transfer characteristics of the analog circuit to identify the direction of the directional touch

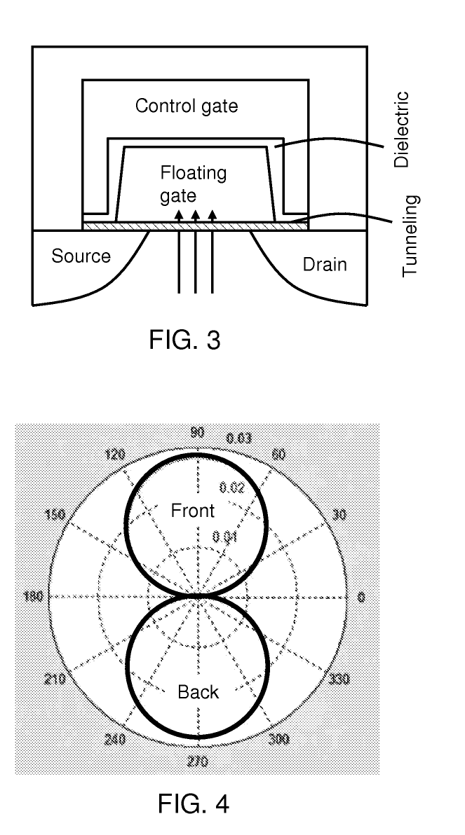

The ultra-low analog circuit can include transconductance amplifiers incorporating floating gates; a configuration that can use fewer transistors than a standard op-amp. Referring to FIG. 3, an exemplary floating gate arrangement of a reverse junction diode suitable for use in the ultra-low analog circuit is shown. The floating gate operates by changing a bias point of the reverse junction diode to change a capacitance which can then be used to change characteristics of the transconductance amplifier. This changes the frequency response of the analog circuit when the transconductance amplifier is used in a feedback path. Specifically, charging a diode in reverse (e.g., a PNP junction biased in reverse) causes a separation (tunneling) of electrons and holes over a dead zone. A larger reverse bias increases the dead zone which causes conduction areas to grow farther apart. Capacitance is a function of the conduction area, permitivity, and distance. Driving the junction in reverse increases the separation distance between the positive and negative regions and increases the capacitance. A capacitor is formed as those charge regions grow apart due to reverse biasing.

Electrons can be deposited onto the floating gate—the surface that holds charge although it is unattached to the junctions—for ultra-low power operation instead of using a voltage source. The reverse junction can be held at a constant voltage, and then the electrons can be regulated onto the floating gate to vary the capacitance. Controlling the capacitance by way of the floating gate in a changes analog characterstics of the transconductance amplifiers in a controlled manner for ultra-lower power operation, and accordingly the frequency response for detecting acoustical sound patterns generated by the fabricated surface 202 responsive to touch. The ultra-low analog circuit in one configuration can efficiently store and process captured acoustical sound patterns as part of a front-end feature extraction process.

In one embodiment, the microphone 111 includes a diaphragm with a front and a back port to delay a propagation of the acoustical sound from the front port to the back port of the diaphragm to create microphone directional sensitivity for identifying the directional touch. As one example, the microphone 111 can be a gradient microphone that operates on a difference in sound pressure level between the front portion and back portion to produce a gradient sound signal. The sensitivity of the gradient microphone changes as a function of position and sound level due to a touching or scratching of the fabricated surface 202. In another arrangement, the microphone 111 can include a first microphone and a second microphone and subtract a first signal received by the first microphone from a second signal received by a second microphone to produce a gradient sound signal. A correction filter can apply a high frequency attenuation to the gradient sound signal to correct for high frequency gain due to the gradient process.

Referring to FIG. 4, an exemplary sensitivity pattern of a gradient microphone is shown. The front port of the gradient microphone where sound is captured corresponds to the top. The sensitivity pattern reveals that the gradient microphone can be made more sensitive to sound arriving at a front and back portion of the gradient microphone, than from the left and right. The sensitivity pattern shows regions of null sensitivity at the left and right locations. Sound arriving at the left and right will be suppressed more than sounds arriving from the front and back. Accordingly, the gradient microphone provides an inherent suppression of sounds arriving at directions other than the principal direction (e.g. front or back) for determining a direction of the directional touch. Processing logic associated with the gradient microphone can switch between directivity patterns based on a level or spectra of ambient sounds, such as those corresponding to the acoustical sound patterns.

The gradient microphone operatively coupled and in combination with the ultra-low power analog circuit can adjust a directivity pattern for detecting directional touch, localized touch, and finger movements on the fabricated surface 202. By way of the floating gate, phase delays can be introduced (analog) into the captured acoustical patterns to control the microphone directivity patterns. As noted, the gradient microphone can include an acoustic sound port on the front and the back. The analog circuit then effectively delays sound front port to the back port of the diaphragm to create different directional patterns. The delay can be controlled to create a figure eight directivity pattern or a cardioid pattern for example by delaying the acoustical signal.

With two microphones an RC network can be formed to adjust the phase by way of the floating gates and accordingly the microphone directionality and sensitivity. The analog RC network with at least two microphones adjusts the phase of network to produce a pure delay. The floating gates adjust a capacitance of an Resistor-Capacitor (RC) network to control the delay. A two-microphone configuration can detect changes in sound pressure level of the acoustical sound pattern between the microphones, and from the changes identify a direction of the directional touch, or identify features of the acoustical sound patterns. Notably, the ultra-low power analog circuit can comprise hundreds or thousands of op-amps to create a frequency response that varies in accordance with a controlled charging of the floating gates for adjusting the microphone directivity and sensitivity pattern.

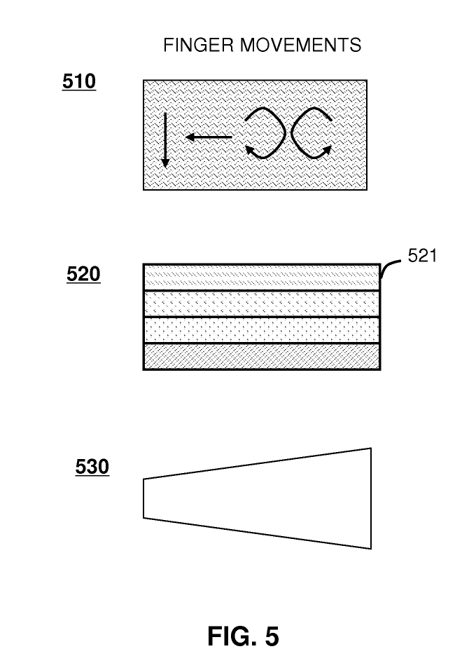

FIG. 5 shows various embodiments of the fabricated surface 202. As illustrated in subplot 510 the fabricated surface 202 can be a function of surface roughness along two dimensions. The surface roughness can change from left to right with a first type of material variation, and change from bottom to top with a second type of material variation so at least two dimensional rubbing directions can be determined. Alternatively, the microphone 111 can be used for left-to-right, and the roughness variation can be used for top-to-bottom to achieve two dimensional sensing. Subplot 520 shows alternating rows of roughness for achieving different spectra based on direction; roughness can be a discrete function of columns, or as a continuous graded surface in two dimensions.

By changing the surface's mechanical properties (e.g., thickness or dimensions) with position (or location), a map of vibration modal patters can be learned to associate with the position (or location). As shown in subplot 530 the surface area of the fabricated surface 202 is shaped to excite different modal patterns based on location. The finger can act to effect (either dampen or excite depending on vibration coupling determined by surface treatment) the modes that the fingertip is overtop of. The acoustical switch 200 can then identify via pattern recognition or feature matching a directional touch by monitoring which modes are excited and dampened over time. For instance, the acoustical sensor switch can employ spectral distortion techniques to determine when an acoustical sound pattern matches a learned pattern, or when particular features such as a resonance (pole) or null (zero) correspond to those of a learned location. For instance, the fabricated shape shown in subplot 530 produces modal patterns with a strong spatial dependence from left to right and up to down which can be used to determine finger motion.

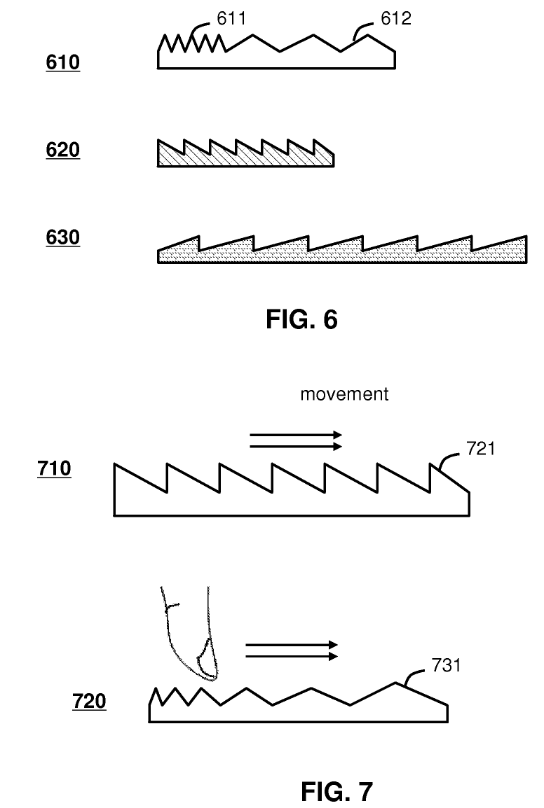

FIG. 6 illustrates exemplary profiles of the fabricated surface. In the embodiment shown the fabricated surface can include structures of roughness, grooved inlets, or graded felt. The structures can vary in length, roughness, and firmness for introducing salient features onto the acoustical sound patterns. The structures respond differently to touch, for example as shown in their spectral envelopes, frequency patterns, and temporal signatures. Other materials can also be fabricated to illicit characteristic sound patterns responsive to directional or localized touch; including light conduction fibers or electrical materials, such as fiber cross junctions (e.g., x-y), electrically conductive nano-fiber, or mesh grids.

Subplot 610 shows one example where the fabricated surface 202 comprises a non-linearly spaced saw-tooth pattern to produce frequency dependent acoustic patterns based on the directional movement of a directional touch on the fabricated surface. The roughness transition of the saw-tooth pattern varies in tooth separation distance, height, and firmness as shown in subplots 620 and 630, to produce differing features. For example with left to right motion, the fabricated surface in subplot 620 has a higher frequency fundamental that is of higher intensity than the lower frequency fundamental generated by the fabricated surface in subplot 630. For right-to-left motion, the fabricated surface in subplot 630 produces a lower frequency fundamental that's louder than the high frequency fundamental generated by the fabricated surface in subplot 620.

With more than one discrete change in roughness property, the acoustic switch 202 can identify changes in the sound and/or vibration spectrum as the finger moves from one surface to the other to determine which direction the finger traveled over a transition region. As one example, the acoustic switch 202 can correlate a spectrum to the two (or more) different surfaces to identify phase and amplitude variations. Predetermined sound patterns can be stored in memory and compared to recently captured sound patterns. It should also be noted that signal processing techniques such as those described in U.S. patent application Ser. No. 11/936,727 and including Gaussian Mixture Models, Hidden Markov Models, and Neural Networks can be incorporated to recognize the acoustical patterns, the entire contents of which are hereby incorporated by reference.

FIG. 7 shows an illustration of an exemplary directional finger motion over two different fabricated surfaces. In subplot 710 the roughness of the fabricated surface is a function of direction. The N sawtooth 721 creates a unique (or sufficiently different) sound generation mechanism depending on the direction due the material shape and structure of the saw tooth. The acoustical sensor switch 200 by way of correlation techniques in the time and/or frequency domain can identify salient features in the produced acoustical sound pattern (or sound spectrum) to detect left-to-right or right-to-left finger motion. As an example, a negative correlation corresponds to a left direction, and a positive correlation corresponds to a right direction. The correlation can be performed in analog circuits or software via matched filtering techniques, delay and add, inner products, Fourier transforms, although other techniques are herein contemplated.

In subplot 720 the surface properties change as a function of location. This permits the acoustical sensor switch 200 to identify changes in the acoustical sound pattern due to finger movement over a specific region of the fabricated surface. In subplot 720, the fundamental sound pattern will change from high frequency to low frequency for left-to-right motion as the finger moves over the grooves 731, or from low freq to high freq fro right to left motion. The acoustic sensor switch 200 can discriminate between a finger tip movement and a finger nail movement across the fabricated surface.

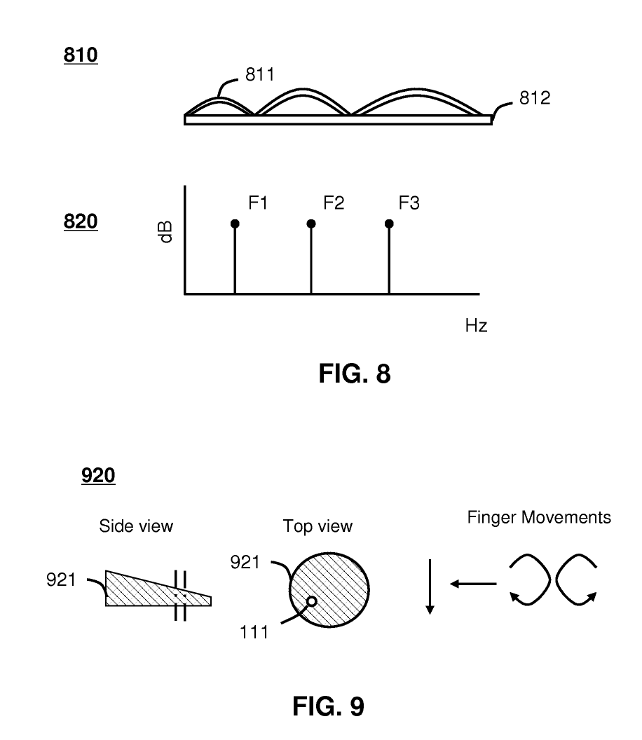

FIG. 8 shows another exemplary embodiment of the fabricated surface comprising modal membranes or plates, or a material with both membrane and plate type behavior. The modal membranes or plates can be drum like structures that for specific shapes and sizes resonate at specific frequencies or otherwise produce repeatable acoustical characteristics. The modal membranes or plates can excite modal acoustic patterns responsive to a directional or localized touch. A membrane can be a stretched sheet whose restoring force comes from the tension in the membrane. A plate can be a rigid surface whose bending forces restore the plates position. As used herein “membrane or plate” can correspond to a surface that exhibits either or both membrane and plate behavior”.

The elastic membranes can also resemble poppies that return to an original shape following touch or depression, and upon doing so generate a characteristic acoustical sound pattern. For instance, the elastic membranes can generate tonal sound frequencies (e.g., F1, F2, F3) as the finger respectively glides across each of the elastic membranes of the fabricated surface. The membranes or plates can also respond to localized touch such as a tapping movement on a membrane of the fabricated surface.

Notably, the fabricated surface is not limited to elastic membranes. For example, the modal membranes can be plastic flexible materials or form retaining polymers. Certain materials or combinations of materials can produce surface structures that also produce modal patterns characteristic of a position or location on the fabricated surface. Moreover, the acoustical switch can sense vibrational movement of an underlying structure supporting the fabricated surface, such as the plastic housing of an earpiece. Thus in addition to the acoustical sensor switch 200 being able to resolve location and movement from acoustical sound patterns, it can pick up underlying mechanical vibrations responsive to finger movements on the fabricated surface.

FIG. 9 shows an acoustical sensor switch 920, comprising a fabricated surface 921 that produces an acoustical sound pattern responsive to a finger movement on the fabricated surface 921, and the microphone 111 within proximity of the fabricated surface to analyze and associate the acoustical sound pattern with a user interface control. The fabricated surface 921 can include physical structures such as grooved inlets or fibers that produce measureable characteristics of the acoustical sound pattern responsive to a directional touch. The directional touch can be a left swipe, right swipe, up swipe, down swipe, clockwise or counter-clockwise circular swipe motion.

The microphone, or processing logic associated with the microphone, 111 can identify changes in the acoustical sound pattern generated from the fabricated surface over time and frequency responsive to the active tapping of a finger on the fabricated surface. The microphone 111 can be asymmetrically positioned on the fabricated surface to distinguish full finger sweeps across the fabricated surface 202. In such an arrangement, the acoustical sensor switch can differentiate between left-right, up-down, and circular finger movements. In such regard, the asymmetrically positioning within the fabricated surface permits the acoustical sensor switch 200 to distinguish approximately straight-line finger-sweeps from a locus of points on the exterior of the fabricated surface inwards toward the microphone.

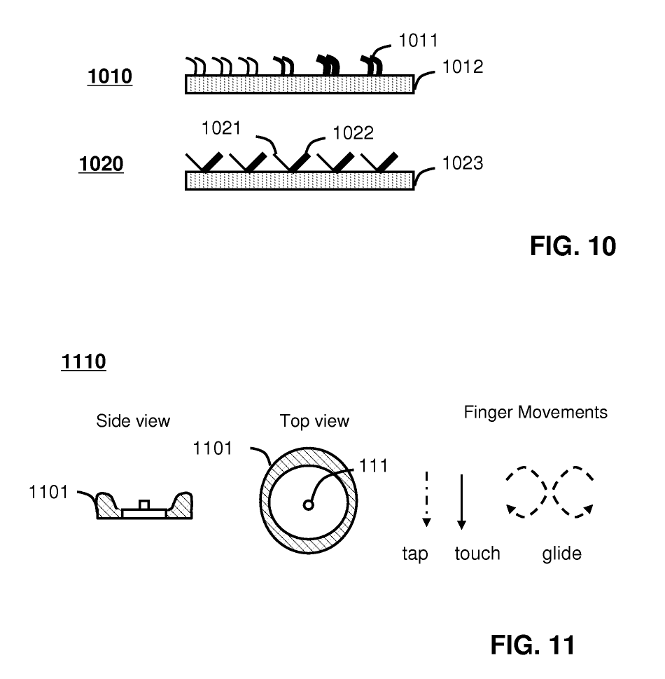

FIG. 10 shows another exemplary embodiment of the fabricated surface comprising cilia type fibers. As illustrated in subplot 1011 the fibers can change in thickness to produce distinguishing acoustical sound and vibration patterns. Although not shown, the fibers can vary in length and material type. Subplot 1010 illustrates a fabricated surface with fibers tuned to specific directional finger movement. For instance, for each fiber pair, the left fibers can be of a different thickness or size than the right fiber. Such directional ‘fur’ comprises surface treatment with fibers of different properties based on direction. The different mass or stiffness of the thicker fibers will generate different sound spectra than the thinner, less massive or less stiff fibers. The acoustical sensor switch 200 can determine rubbing direction based on analysis of the acoustical sound patterns, or sound spectra.

FIG. 11 shows another form of the acoustical sensor switch 1110 with a fabricated surface 1101 that is circumferential to the microphone 111. A cross section of the fabricated surface 1101 is shown in the side view. The raised rounded bevel of the fabricated surface provides the user with tactile feedback during finger movement, and assists the user with recognizing where the finger is during movement. As one example, the user can touch the fabricated at the top, bottom, left or right to perform a specific user interface command, such as increase volume, decrease volume, next media, previous media, respectively. The acoustical sensor can also differentiate between glides such as a top-to-right clockwise glide versus a top-to-left counterclockwise glide. Other finger actions such as a downward sweep that touches the top and then the bottom of the beveled surface at a sequential time can be identified. The acoustical sensor switch 1101 can also discriminate between a touch on the fabricated surface 1101 and a touching of the microphone at the center. The user can also glide along the fabric surface for instance in a clockwise motion to increase the volume, or a counterclockwise motion to decrease the volume. Notably, the configuration of the fabricated sensor shown in FIG. 11 permits detection of both finger-tapping (e.g., up down finger movement at a particular location), or continuous finger motion (e.g., gliding the finger around the periphery).

The microphone 111 serves a dual purpose for voice and audio pickup and also as a switch. Processing logic by way of pattern matching can determine when an acoustical signal corresponds to voice and to finger touches. The logic is embedded into the switch to provide digital output to alert a processing block, for instance to relay the voice signal to a voice processing unit, or to a pattern recognition unit to recognize a finger movement. The processing logic can also separate a combined signal comprising a voice signal and a finger touch signal. For instance, independent component analysis can estimate a decorrelation matrix from learned finger patterns to isolate the voice signal. Adaptive filters can also be used to unmix the voice signals from the finger touch signals when concurrently captured by the microphone. The acoustical sensor switch can also operates in a low power processing mode to periodically poll an acoustical signal from the microphone, or a peak hold version of the audio signal to enter a wake mode responsive to identifying recent acoustic activity.

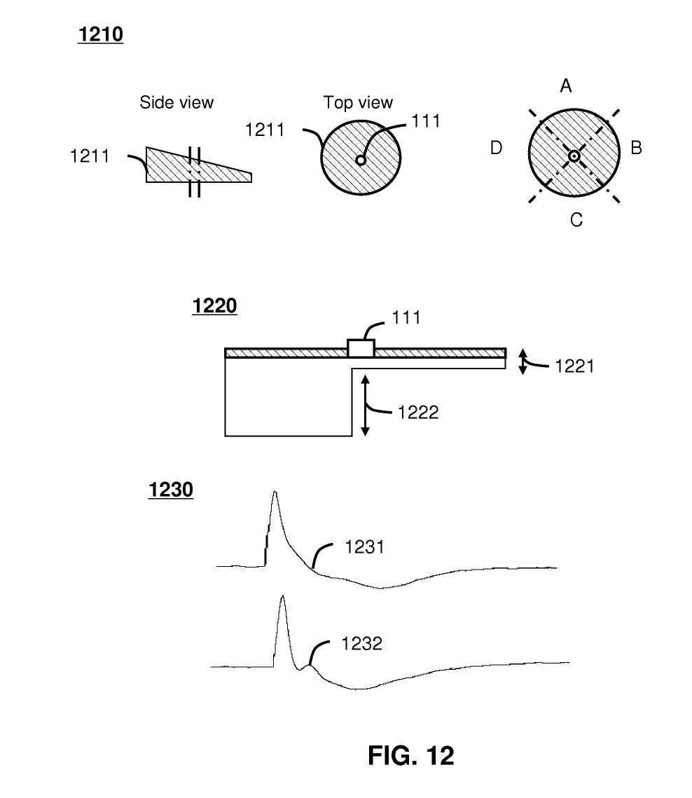

FIG. 12 shows another embodiment of an acoustical sensor switch 1210 comprising a fabricated surface 1211 to produce an acoustical sound pattern responsive to a localized touch, and the microphone 111 within proximity of the fabricated surface 1211 to identify a location of the localized touch responsive to detecting the acoustical sound pattern for operating at least one user interface control. The localized touch can be a finger tapping of the fabricated surface at a predetermined location, for example within region A, B, C and D. Each region can comprise a fabricated material with different structures to illicit unique acoustical sound patterns upon touch or tapping. In one configuration, a cross section of the fabricated surface is shown in the side view to slope downward to change the acoustical properties (e.g., firmness) and impart measurable sound qualities characteristics. Processing logic associated with the acoustical sensor switch 1210 can discriminate between a finger-tip slide and a finger-nail tapping on the fabricated surface corresponding to different user interface controls. The processing logic can identify a location of the finger tapping where the location corresponds to the user interface control.

Variation in the mechanical properties of the fabricated surface or underlying support system (e.g., plastic housing) can also be configured to change the sound and vibration spectrum signature. For instance, if the surface roughness is constant, but the mechanical properties of the material under the surface change, then the sound and vibration spectrums changes with location of the touch. As illustrated in subplot 1220, the thinner wall 1221 will generate more high frequencies than the thicker wall 1222. The side view shows how the mechanical properties of the material (e.g., thickness) change with position, though the roughness is kept constant. The acoustical sensor by way of the microphone 111 can monitor the acoustical sound patterns to determine if the finger is rubbed over the surface from left to right or right to left, or any other relative direction, or if the finger is tapped at a specific location.

It should also be noted that the underlying structure can comprise cavities to impart different resonance characteristics to the acoustical sound pattern responsive to a tapping on the fabricated surface above a cavity. As previously indicated the microphone can sense and identify vibrations in the underlying structure. For instance, a volume of a plastic housing supporting the fabricated material 1211 can be constructed to create cavities for different tube model effects. The sound reflections on a cavity or tube can be modeled and saved for comparison. As one example, an all-pole model (e.g., cepstral, LPC, parcorr, coefficients) can be generated during a training phase, and compared against an all-pole model upon detecting a finger tap to identify where the user is tapping the finger on the fabricated surface. A Gaussian Mixture Model, Hidden Markov Model, or Neural Network can be used to model the acoustical sound patterns during the training phase.

As previously noted, the fabricated surface 1211 can similarly include structures of rough texture, grooved inlets, elastic membranes, cilia fibers, or graded felt in addition to sound cavities or thickness. The structures vary in length and firmness to produce sound patterns characteristic to a location or finger movement. As the finger moves across the fabricated surface, sound patterns are generated characteristic to structural properties of the fabricated surface 1211. The acoustical sensor switch 1210 can sense vibration and/or acoustic born sound patterns generated by a finger moving or swiping along a surface of the fabricated surface 1211 to control a switch state. Processing logic can identify a location of the finger tapping and the location corresponds to the user interface control.

Subplot 1230 illustrates a plot 1231 of a finger tap at a location above the thin wall 1221, and a plot 1232 of a finger tap at a location above the thick wall 1222. The time domain plot indicates that the thin wall produces a bump after the impulse that is absent in the plot for the thick wall; the results characteristic to numerous finger taps. Similarly, cavities or material properties can alter the representative features which can be detected by the acoustical sensor switch. For instance, larger cavity sections or volumes of air can impart resonant qualities or features. The acoustical sensor switch by way of spectral analysis, correlation, differencing, peak detection, matched filtering, or other signal processing detection techniques can identify and distinguish the features for determining where the finger tapping occurred on the fabricated surface or a finger movement on the fabricated surface.

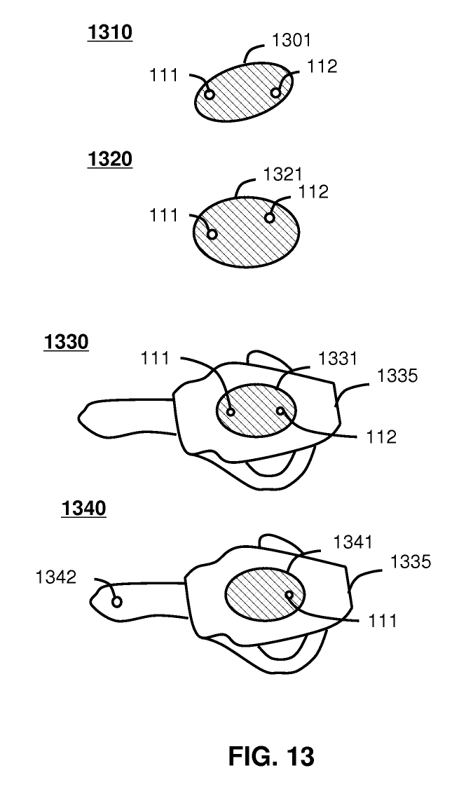

FIG. 13 illustrates an exemplary embodiment of an acoustical sensor switch 1310 with two microphones. The two microphones can be positioned approximately peripheral to the fabricated surface 1301 to detect finger taps or finger movements on the fabricated surface. It should be noted that the acoustical sensor switch 1310 can include more than the two microphones. As illustrated, the fabricated surface 1301 can be oblong in shape with the symmetrically or asymmetrically positioned microphones 111 and 112. Alternatively, as shown in subplot 1320 the fabricated material 1321 can be symmetrical in shape with asymmetrically positioned microphones 111 and 112.

In the dual microphone arrangement shown, the acoustical sensor switch 1310 can localize the a location of a finger tap, or track a location of a finger movement, by monitoring the acoustical sound patterns generated responsive to the finger touch. Specifically, processing logic can measure a time of flight and a relative phase of a sound wave that travels to the first and second microphone. The acoustical sensor switch 1310 can then identify an approximate absolute location and a relative movement from the time of flight and phase information. In one arrangement, principles of echo-location described in U.S. Pat. No. 7,414,705 can be employed to track the finger location and movement. Specifically, the time of flight can be estimated between the finger and a microphone instead of a round trip time of flight from a transmitter to the finger to a microphone.

Subplot 1330 shows another exemplary embodiment of the acoustical sensor switch as part of an earpiece where two microphones are on the fabricated surface. The acoustical sensor switch can be integrated with or mounted to the earpiece 1335. The earpiece comprises a material surface 1331 to produce an acoustical sound pattern responsive to a touching of the material surface on the earpiece 1335, at least one microphone 111 to measure the acoustical sound pattern of the touching, and a processor operatively coupled to the microphone to perform a user interface action responsive to identifying the acoustical sound pattern. The or dual microphone configuration can identify a location of the touching to associate with the user interface action, a direction of the touching to associate with the user interface action, or a combination thereof. The user interface action can be a volume adjustment, equalization adjustment, song selection, media selection, call control, or user interface control. As noted previously, the material surface can be a modal membrane with variations in stiffness, tension, thickness, or shape at predetermined locations on the modal membrane to excite different modal patterns. The acoustical sensor switch can recognize a left swipe, right swipe, up swipe, down swipe, tapping movement, clockwise or counter-clockwise circular swipe motion for controlling operation of the earpiece 1335.

Subplot 1340 shows an exemplary embodiment of the acoustical sensor switch where only one microphone 111 is required to detect directional or localized touch, for example, as previously described using graded surfaces of roughness or modal membranes. A secondary microphone 1342, for example to capture voice, if present, can also be employed to improve a signal to noise ratio of the acoustical sound pattern. Adaptive noise suppression, beam forming, adaptive beam-forming, interference, echo suppressors, and sidelobe cancellers, and LMS filtering techniques can be applied to isolate the acoustical sound patterns from ambient noise, the user's own voice, or from music playing out the earpiece.

A method of operating the earpiece can comprise recognizing an acoustical sound pattern generated in response to a touching of a material surface of the earpiece, and associating the acoustical sound pattern with a user interface action to control operation of the earpiece. The method can include detecting a phase delay of one or more acoustical sound patterns captured by one or more microphones and determining an intended user interface action based on the phase delay. The method can include monitoring a sound pressure level at a first microphone to detect whether a finger traveling along the material surface is approaching or departing relative to the microphone.

The method can include monitoring a sound pressure level at a first microphone and a second microphone responsive to a finger moving along the material surface, tracking the finger movement along the material surface in two-dimensions based on changes in the sound pressure level, and recognizing finger patterns from the tracking to associate with the user interface action. The material surface can be approximately centered between the first microphone and the second microphone. The material surface may be on the order of 2-3 cm in length.

Correlations among acoustical sound patterns can be measured as a finger touching the material surface moves from a first region of the material surface to another region of the material surface to determine which direction the finger is traveling on the material surface. For instance, a two-dimensional correlation in a time-domain or frequency domain can be performed to detect a finger motion on the material surface that is a left swipe, right swipe, up swipe, down swipe, tapping movement, clockwise or counter-clockwise circular swipe motion. As one example, trigonometric and angular velocities of a tracking vector can be monitored for identifying finger movements and patterns. A speed of the finger movement can be measured across the fabricated surface, and the user interface control adjusted in accordance with the speed.

The method can include analyzing a frequency content of acoustical sound patterns during the touching to determine a direction and movement of a finger along the material surface, where the material surface comprises an underlying structure with differing mechanical properties that alter the frequency content. The mechanical properties can vary in thickness, stiffness, or shape and include a thin layer that produces higher frequencies and a thick layer that produces lower frequencies. The microphone can be embedded in a housing of the earpiece to sense vibration of the housing responsive to finger movement on the fabricated surface of the earpiece.

The method can further include programming a capacitance of a floating gate of an ultra-low power analog circuit microphone to adjust a directionality of the microphone. A phase delay can be introduced between the acoustical sound pattern captured at a first port and the same acoustical sound pattern captured at a second port to generate a directional sensitivity for increasing a signal to noise ratio of the acoustical sound pattern.

The method can include learning acoustical sound patterns for custom fabricated surfaces, generating models for the sound patterns as part of the learning, and saving the models for retrieval upon the occurrence of new sound patterns. The models can be neural network models, gaussian mixture models, or Hidden Markov Models. Furthermore, the method can include activating speech recognition responsive to detecting a finger tapping pattern of the microphone, and loading a word recognition vocabulary specific to the finger tapping or a location of the finger tapping. A second finger tapping following the speech recognition of a spoken utterance can adjust a user interface control. Alternatively, or in combination, speech recognition can be activated responsive to detecting a finger gesture pattern on the fabricated surface, followed by a loading of a word recognition vocabulary specific to the finger gesture pattern.

For instance, a user desiring to adjust an audio control, can tap twice on the acoustical sensor switch to activate speech recognition. The user can then say ‘audio’ which the earpiece will then recognize and configure the fabricated surface for audio controls. A left or right finger tap can scan through audio settings (e.g., volume, treble, bass) which are audibly played to the user by the earpiece. The user stops at an audio control (volume), and then proceeds to tap on the top or bottom of the fabricated surface to adjust the volume up or down. Similarly, the user can scroll through media selections of voice mails to select and play songs via a combination of speech recognition and finger touch (tapping, glides, sweeps) on the acoustical sensor switch.

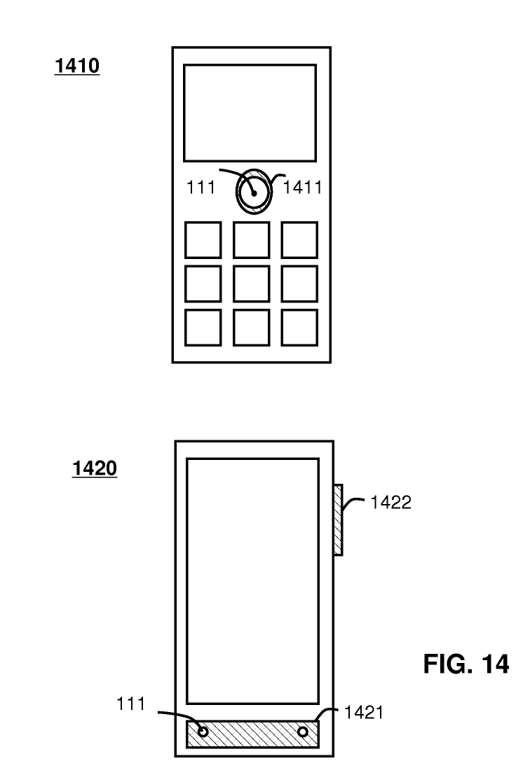

FIG. 14 shows other exemplary embodiments of the acoustical sensor switch with a mobile device. As illustrated in subplot 1410, the acoustical sensor switch 1411 can be positioned at a thumb accessible location, for instance using the raised bevel configuration of FIG. 11 to permit thumb glides or thumb taps. The acoustical sensor switch 141 can be integrated with the mobile device that exposes an Applications Programming Interface for user interface communication. In such a configuration, the microphone 111 can serve a dual purpose for voice capture and user interface control. It should be noted that more microphones can be present on the mobile device for example at the corners to pick up voice when the user is touching the microphone 111 for user interface control while speaking.

Subplot 1420 shows an embodiment where the acoustical sensor switch is placed near the bottom of the mobile device. In this configuration, the microphones 111 are peripheral to the fabricated surface 1421 so as to capture voice signals even when the user is touching the fabricated surface 1421.

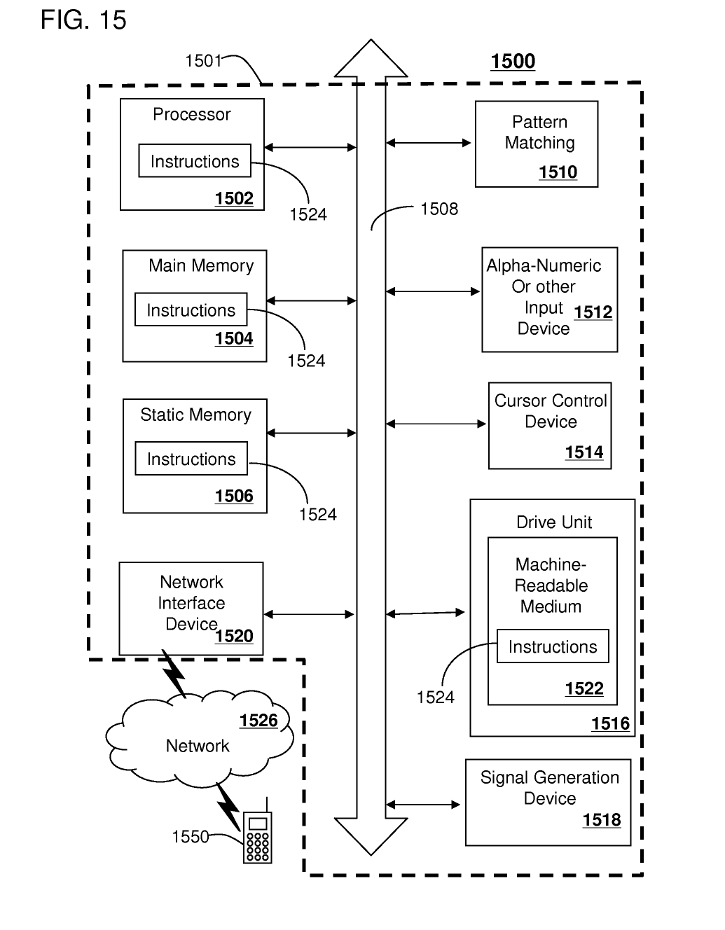

FIG. 15 depicts an exemplary diagrammatic representation of a machine in the form of a computer system 1500 within which a set of instructions, when executed, may cause the machine to perform any one or more of the methodologies discussed above. In some embodiments, the machine operates as a standalone device. In some embodiments, the machine may be connected (e.g., using a network, mobile network, Wi-Fi, Bluetooth) to other machines. In a networked deployment, the machine may operate in the capacity of a server or a client user machine in server-client user network environment, or as a peer machine in a peer-to-peer (or distributed) network environment.

The machine may comprise a server computer, a client user computer, a personal computer (PC), a tablet PC, a laptop computer, a desktop computer, a control system, a mobile device, an earpiece, a network router, switch or bridge, or any machine capable of executing a set of instructions (sequential or otherwise) that specify actions to be taken by that machine. It will be understood that a device of the present disclosure includes broadly any electronic device that provides voice, video or data communication. Further, while a single machine is illustrated, the term “machine” shall also be taken to include any collection of machines that individually or jointly execute a set (or multiple sets) of instructions to perform any one or more of the methodologies discussed herein.

The computer system 1500 may include a processor 1502 (e.g., a central processing unit (CPU), a graphics processing unit (GPU, or both), a main memory 1504 and a static memory 1506, which communicate with each other via a bus 1508. The computer system 1500 may further include a video display unit 1510 (e.g., a liquid crystal display (LCD), a flat panel, a solid state display, or a cathode ray tube (CRT)). The computer system 1500 may include an input device 1512 (e.g., a keyboard), a cursor control device 1514 (e.g., a mouse), a mass storage medium 1516, a signal generation device 1518 (e.g., a speaker or remote control) and a network interface device 1520.

The mass storage medium 1516 may include a computer-readable storage medium 1522 on which is stored one or more sets of instructions (e.g., software 1524) embodying any one or more of the methodologies or functions described herein, including those methods illustrated above. The computer-readable storage medium 1522 can be an electromechanical medium such as a common disk drive, or a mass storage medium with no moving parts such as Flash or like non-volatile memories. The instructions 1524 may also reside, completely or at least partially, within the main memory 1504, the static memory 1506, and/or within the processor 1502 during execution thereof by the computer system 1500. The main memory 1504 and the processor 1502 also may constitute computer-readable storage media.

Dedicated hardware implementations including, but not limited to, application specific integrated circuits, programmable logic arrays and other hardware devices can likewise be constructed to implement the methods described herein. Applications that may include the apparatus and systems of various embodiments broadly include a variety of electronic and computer systems. Some embodiments implement functions in two or more specific interconnected hardware modules or devices with related control and data signals communicated between and through the modules, or as portions of an application-specific integrated circuit. Thus, the example system is applicable to software, firmware, and hardware implementations.

In accordance with various embodiments of the present disclosure, the methods described herein are intended for operation as software programs running on a computer processor. Furthermore, software implementations can include, but not limited to, distributed processing or component/object distributed processing, parallel processing, or virtual machine processing can also be constructed to implement the methods described herein.

The present disclosure contemplates a machine readable medium containing instructions 1524, or that which receives and executes instructions 1524 from a propagated signal so that a device connected to a network environment 1526 can send or receive voice, video or data, and to communicate over the network 1526 using the instructions 1524. The instructions 1524 may further be transmitted or received over a network 1526 via the network interface device 1520.

While the computer-readable storage medium 1522 is shown in an example embodiment to be a single medium, the term “computer-readable storage medium” should be taken to include a single medium or multiple media (e.g., a centralized or distributed database, and/or associated caches and servers) that store the one or more sets of instructions. The term “computer-readable storage medium” shall also be taken to include any medium that is capable of storing, encoding or carrying a set of instructions for execution by the machine and that cause the machine to perform any one or more of the methodologies of the present disclosure.

The term “computer-readable storage medium” shall accordingly be taken to include, but not be limited to: solid-state memories such as a memory card or other package that houses one or more read-only (non-volatile) memories, random access memories, or other re-writable (volatile) memories; magneto-optical or optical medium such as a disk or tape; and carrier wave signals such as a signal embodying computer instructions in a transmission medium; and/or a digital file attachment to e-mail or other self-contained information archive or set of archives is considered a distribution medium equivalent to a tangible storage medium. Accordingly, the disclosure is considered to include any one or more of a computer-readable storage medium or a distribution medium, as listed herein and including art-recognized equivalents and successor media, in which the software implementations herein are stored.

Upon reviewing the embodiments disclosed, it would be evident to an artisan with ordinary skill in the art that said embodiments can be modified, reduced, or enhanced without departing from the scope and spirit of the claims described below. Other suitable modifications can be made to the present disclosure. Accordingly, the reader is directed to the claims below, which are incorporated by reference, for a fuller understanding of the breadth and scope of the present disclosure.

Where applicable, the present embodiments of the invention can be realized in hardware, software or a combination of hardware and software. Any kind of computer system or other apparatus adapted for carrying out the methods described herein are suitable. A typical combination of hardware and software can be a mobile communications device with a computer program that, when being loaded and executed, can control the mobile communications device such that it carries out the methods described herein. Portions of the present method and system may also be embedded in a computer program product, which comprises all the features enabling the implementation of the methods described herein and which when loaded in a computer system, is able to carry out these methods.

While the preferred embodiments of the invention have been illustrated and described, it will be clear that the embodiments are not so limited. Numerous modifications, changes, variations, substitutions and equivalents will occur to those skilled in the art without departing from the spirit and scope of the present embodiments of the invention as defined by the appended claims.

What is claimed is:

1. An acoustical sensor, comprising
a fabricated surface that produces an acoustical sound signature responsive to a finger movement thereon;
a microphone within proximity of the fabricated surface to capture the acoustical sound signature, where the microphone dually serves to capture acoustic voice signals, and
a processor associated communicatively coupled to the microphone that discriminates the acoustic voice signals and identifies the acoustical sound signature from
i) vibrations of an underlying structure coupled to the fabricated surface, and
ii) acoustical sound pressure waves of the acoustical sound signature generated in air, and
analyzes and associates the acoustical sound signature with a user interface control for operating a mobile device or earpiece attached thereto, where the microphone is adjacent to the fabricated surface or positioned within the fabricated surface.

2. The acoustical sensor of claim 1, where the processor identifies locations of the finger movements corresponding to user interface controls; and
discriminates between finger touches, tapping, and sliding on the fabricated surface at the locations,
where the finger movement is a left, right, up, down, clockwise or counter-clockwise circular movement,
and the fabricated surface comprises an underlying structure that vibrates in response to the finger movement according to a structural modality.

3. The acoustical sensor of claim 1, where the processor determines a direction of the finger movement by analyzing amplitude and frequency characteristics of the acoustical sound signature and comparing them to time segmented features of recorded sounds from the fabricated surface, where the fabricated surface comprises structures of grooved inlets, elastic membranes, cilia fibers, or graded felt that vary in length and firmness.

4. The acoustical sensor of claim 3, where the processor
identifies changes in the acoustical sound signatures generated from the fabricated surface over time and frequency responsive to a sweeping of the finger across the fabricated surface,
where the fabricated surface is manufactured to exhibit surface treatment and physical structures that produce distinguishing characteristics of the acoustical sound signature responsive to directional touch.

5. The acoustical sensor of claim 1, where the fabricated surface comprises a non-linearly spaced saw tooth pattern to produce frequency dependent acoustic patterns based on the directional movement of directional touch on the fabricated surface.

6. The acoustical sensor of claim 1, where the fabricated surface is a function of surface roughness along two dimensions, and
the surface roughness changes from left to right with a first type of material variation, and
the surface roughness changes from bottom to top with a second type of material variation, so at least two dimensional rubbing directions can be determined.

7. The acoustical sensor of claim 1, where the microphone comprises an ultra-low analog circuit with at least one reverse diode junction to set a capacitance and establish a frequency response for identifying the direction of the finger movement.

8. The acoustical sensor of claim 1, where the microphone is asymmetrically positioned within the fabricated surface for distinguishing approximately straight-line finger-sweeps from a locus of points on the exterior of the fabricated surface inwards toward the microphone, or, oblong for distinguishing a direction of an approximately straight-line finger sweep from an exterior of the fabricated surface inwards to the microphone.

9. The acoustical sensor of claim 1, comprising a second microphone, where the fabricated surface approximates an elliptical pattern and the first microphone and second microphone are positioned at approximately the focal points of the elliptical pattern, where processor tracks finger movement across the fabricated surface by time of flight and phase variations of the acoustical sound signatures captured at the first and second microphone and distinguishes between absolute finger location based on time of flight and relative finger movement based on phase differences for associating with the user interface controls.

10. An acoustical sensor suitable for an earpiece, comprising
a fabricated surface to produce an acoustical sound signature responsive to a surface slide finger movement and localized finger tap;
a microphone within proximity of the fabricated surface to capture the acoustical sound signature; and
a processor to identify a movement and location of the localized touch responsive to detecting the acoustical sound signature for operating a user interface control of the earpiece,
where the fabricated surface is directional dependent by way of surface treatment that disposes grooved, jagged, graded, textured, or cilia structures or fibers.

11. The acoustical sensor of claim 10, where the microphone comprises a low power analog circuit to set a capacitance that establishes a characteristic frequency response and recognize an acoustical sound signature at a location on the fabricated surface, and the analog circuit comprises a programmable or adaptive floating gate that
changes analog transfer characteristics of the analog circuit to identify the direction of the directional touch, and
adjusts the frequency response by way of a controlled electron source to adjust the capacitance of the floating gate.

12. The acoustical sensor of claim 10, where the fabricated surface comprises a modal membrane or plate or combination thereof that excites modal acoustic patterns responsive to the localized touch, and the localized touch is a finger touch, tap or slide movement on a modal zone of the fabricated surface, where the material surface is a modal membrane that by way of the localized touch excites modal acoustic patterns detected by the microphone.

13. The acoustical sensor of claim 10, wherein the microphone includes a diaphragm with a front and a back port to delay a propagation of the acoustical sound signature from the front port to the back port of the diaphragm to create microphone directional sensitivity patterns for identifying the direction of the directional touch,
where the processor introduces a phase delay between the acoustical sound signature captured at the front port and the same acoustical sound signature captured at the back port to generate a directional sensitivity for increasing a signal to noise ratio of the acoustical sound signature.

14. The sensor switch of claim 10, comprising a second microphone positioned to detect changes in sound pressure level of the acoustical sound signature between the at least one more microphones, and from the changes identify a direction of the finger movement from the acoustical sound signatures.

15. The sensor of claim 10, where processor
digitally separates and suppresses acoustic waveforms caused by the finger movement on the fabricated surface from acoustic voice signals captured at the microphone according to detected vibrations patterns on the fabricated surface, and
operates in a low power processing mode to periodically poll the voice signals from the microphone to enter a wake mode responsive to identifying acoustic activity.

16. An earpiece, comprising:
a fabricated surface to produce an acoustical sound and vibration patterns responsive to a finger movement on the fabricated surface on the earpiece;
a microphone to capture the acoustical and vibration sound signatures due to the finger movement; and
a processor operatively coupled to the microphone to analyze and identify the high frequency acoustical and low frequency vibration sound signatures and perform a user interface action therefrom,
where the microphone is embedded in a housing of the earpiece to sense acoustic vibration responsive to finger movement on the fabricated surface of the earpiece,
where the fabricated surface is a grooved plastic, jagged plastic, a graded fabric, a textured fiber, elastic membranes, or cilia fibers.

17. The earpiece of claim 16, where the fabricated surface varies in stiffness, tension, thickness, or shape at predetermined locations to produce acoustical sound signatures characteristic to a location of a finger tap on the fabricated surface, and
the processor identifies a location of the finger tap to associate with the user interface action, a direction of the touching to associate with the user interface action, or a combination thereof.

18. The earpiece of claim 16, where the processor
monitors a sound pressure level at a first microphone and a second microphone responsive to a finger moving along the material surface;
tracks the finger movement along the material surface based on changes in the sound pressure level and frequency characteristics over time;
recognizes finger patterns from the tracking to associate with the user interface action; and
determines correlations among acoustical sound signatures as a finger touching the material surface moves from a first region of the fabricated surface to another region of the fabricated surface to determine which direction the finger is traveling,
where the processor detects form the correlations a finger motion on the fabricated surface that is a left, right, up, down, tap, clockwise or counter-clockwise circular movement.

19. The earpiece of claim 16, where the mechanical properties vary in thickness, stiffness, or shape and include a thin layer that produces higher frequencies and a thick layer that produces lower frequencies.

20. The earpiece of claim 16, where the processor:
learns acoustical sound signatures for custom fabricated surfaces;
generates models for the sound signatures as part of the learning; and
saves the models for retrieval upon the occurrence of new sound signatures,
where the models are Neural Network Models, Gaussian Mixture Models, or Hidden Markov Models.
